(19) United States
(12) Patent Application Publication
(10) Pub. No.: US 2014/0118196 A1
(43) Pub. Date: May 1, 2014

(54) MODULAR CELL ANTENNA APPARATUS AND METHODS

(71) Applicant: Pulse Finland OY, Kempele (FI)

(72) Inventor: Kimmo Koskiniemi, Oulu (FI)

(21) Appl. No.: 13/794,290

(22) Filed: Mar. 11, 2013

Related U.S. Application Data
(60) Provisional application No. 61/718,637, filed on Oct. 25, 2012.

(51) Int. Cl. H01Q 1/42; B29C 65/00

(52) U.S. Cl. CPC H01Q 1/42; B29C 65/00
USPC 343/702; 343/872; 156/245

(57) ABSTRACT

Simple, low-cost and modular antenna apparatus and methods associated therewith. In one embodiment, a modular antenna element that can be used either alone or as a basic “building block” for larger arrays and sectorial antennas (i.e., by joining needed number of elements together) is provided. The same parts can be reused for various complete product designs, thereby advantageously reducing the need for customized parts (and the attendant disabilities associated therewith). Moreover, multiple antenna elements can be readily joined together via a common feed network (in one implementation, via the back portion of each element). The antenna gain and beam width are also adjustable through configuration of the array (and the construction of the antenna elements themselves).

### PRIORITY

This application claims priority to co-owned and co-pending U.S. Provisional Patent Application Ser. No. 61/718,637 filed Oct. 25, 2012 of the same title, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technology Field

The present disclosure relates generally to antenna apparatus for use in electronic devices such as wireless radio devices, and more particularly in one exemplary aspect to a spatially compact antenna apparatus useful on e.g., a base station or access point, and methods of manufacturing and utilizing the same.

2. Description of Related Technology

Radio frequency antennas are now pervasive in modern electronics, due to the widespread adoption of wireless interfaces for communication. Typical wireless applications often include some form of base station or access point, which is in data communication with a broader network, as well as one or more client or mobile devices. Alternatively, a one-way architecture may be employed (such as in the case of a GPS or GLONASS receiver receiving signals from one or more satellites).

Depending on the host device form factor (e.g., base station, mobile user device, etc.) and performance requirements, various physical configurations of antennas are utilized. Such configurations employ mechanical components to, inter alia, support the antenna radiating element(s) and related electrical/electronic components, provide environmental protection, etc. In prior art solutions, such mechanical components are typically customized for each specific antenna configuration. This approach is not optimal, in that a custom design and manufacturing cycle is typically required for each different configuration. This results in comparatively high tooling costs, and longer design cycles; the possibility of reuse of the components on any other design project/configuration is minimal as well.

Moreover, the logistics of supporting such customized configurations is not optimized. For example, different part numbers, storage/inventory, assembly lines/manufacturing equipment, materials, specifications and drawings, etc. are necessitated to support such a wide array of sui generis designs, thereby increasing labor and other costs, and ultimately the cost of the product to the host device manufacturer.

Accordingly, there is a salient need for an improved antenna solution that can provide the required electrical and other performance attributes, along with a higher degree of commonality and “reuse” opportunity, at a lower cost and complexity.

### SUMMARY

The present invention satisfies the foregoing needs by providing, inter alia, improved apparatus and methods for modular and low-cost antenna design, construction and implementation, and methods associated therewith.

In a first aspect of the invention, an antenna element is disclosed. In one embodiment, the element includes: a cover element having a cavity formed therein; a main radiating element disposed substantially within the cavity; and a coupling element configured to at least electrically couple the antenna element to a host radio frequency device.

In one variant, a parasitic radiating element is formed substantially on or within the cover element; the parasitic radiating element comprises e.g., a laser direct structured (LDS) element formed on an exterior surface of the cover element.

In another variant, the element further includes an out layer disposed over the exterior surface and at least a portion of the parasitic radiating element, the outer layer selected so as to not substantially degrade the electrical performance of at least the parasitic element.

In a further variant, the antenna element further includes a back housing element configured to cooperate with the cover element so as to substantially enclose the cavity, and a ground plane disposed on the back housing.

In another variant, the antenna element comprises a substantially modular construction that is configured to enable the antenna element to be mated with at least one other similar or identical antenna element so as to form an array.

In a second aspect, an antenna array is disclosed. In one embodiment, the array includes: a plurality of substantially identical antenna elements each having: a cover element having a cavity formed therein; a main radiating element disposed substantially within the cavity; a parasitic radiating element formed substantially on or within the cover element; and a coupling element configured to at least electrically couple the antenna element to a host radio frequency device; and a feed structure configured to commonly feed each of the antenna elements.

In one variant, the array comprises the plurality of antenna elements arranged in a substantially planar array.

In another variant, the array comprises the plurality of antenna elements arranged in a substantially three-sector radial array.

In a further variant, the antenna array further includes a circuit board disposed proximate each of the antenna elements, the circuit board further comprising at least one radio frequency transceiver configured to provide a radio frequency signal to the feed network so as to drive each of the individual antenna elements.

In a third aspect of the invention, a method of manufacturing an antenna element is disclosed. In one embodiment, the method includes forming a parasitic radiator on at least a portion of a surface of an antenna radome, with a main radiator disposed substantially within an interior region of the radome. Laser direct structuring (LDS) is used in one variant to form the parasitic radiator (as well as a feed network on the back portion of the antenna element) so as to economize on space and simplify manufacturing.

In a fourth aspect of the invention, an LDS-based antenna element is disclosed. In one embodiment, a “two-shot” modling process is used to form a radome and back cover element of the antenna element, each having specifically identified areas that contain LDS-suitable polymer so as to enable formation of an antenna or conductive trace thereon. The remaining portions of the radome/back cover are formed from a non-LDS enabled polymer such as ABS.

In a fifth aspect of the invention, a simplified antenna feed arrangement is disclosed. In one embodiment, the arrangement includes a conductive clip (e.g., C-shaped) such that custom or expensive connectors or cables used in prior art antenna feeds are obviated; the clip may merely be soldered to (or simply maintain frictional contact) with a trace or other component of the host device when the element is placed in its mounting disposition. In one variant, the clip is coupled to an LDS feed network on the antenna element, which further simplifies the feed structure.

In a sixth aspect of the invention, a method of reconfiguring an antenna array is disclosed. In one embodiment, the method includes selectively removing one or more modular antenna elements from an existing array, and placing the removed elements in a second, different configuration so as to provide different electrical and/or antenna physical (e.g., azimuthal coverage) properties.

In a seventh aspect of the invention, a method of manufacturing a low-cost, simplified antenna element is disclosed. In one embodiment, the method includes: forming a front cover element and a rear cover element, at least one of the front and rear cover elements formed using first and second types of material; activating relevant portions of at least one of the front and rear covers containing the first type of material; utilizing an electroless process so as to accrete a plurality of conductive elements on the activated portions; disposing a ground plane onto the back cover element; disposing a main radiator element on the back cover element; affixing a feed conductor to at least one of the accreted conductive elements; and joining the front and rear cover elements.

Further features of the present invention, its nature and various advantages will be more apparent from the accompanying drawings and the following detailed description.

### BRIEF DESCRIPTION OF THE DRAWINGS

The features, objectives, and advantages of the disclosure will become more apparent from the detailed description set forth below when taken in conjunction with the drawings, wherein:

FIGS. 1A and 1B are front elevation views of first and second embodiments of a low-cost modular antenna element configured according to the disclosure, respectively.

FIG. 1C is a cross-sectional view of the antenna element of FIG. 1B taken along line 1C-1C, showing the interior components and construction thereof.

FIG. 1D is a detail of the feed network region of the antenna element shown in FIG. 1C.

FIGS. 2A-2D illustrate various possible polarizations imparted by the antenna element of FIGS. 1A-1B, including dual polarization (+/−45 degrees and 90 degrees), and single polarization (vertical, horizontal).

FIG. 3 is a top elevation view of one exemplary embodiment of an antenna array apparatus according to the disclosure (hexagonal; six-sector; 360-degree).

FIG. 4 is a top elevation view of another exemplary embodiment of an antenna array apparatus according to the disclosure (hexagonal; three-sector; 360-degree).

FIG. 5 is a top elevation view of another exemplary embodiment of an antenna array apparatus according to the disclosure (planar; two-sector; for e.g., wall or ceiling mounting).

FIG. 6 is a top elevation view of yet another exemplary embodiment of an antenna array apparatus according to the disclosure (hemispherical; three-sector; 180-degree).

FIG. 7 is a side elevation view of one exemplary embodiment of an antenna array apparatus according to the disclosure, configured for pole mounting (rectangular four-sector array plus fifth upward sector).

FIG. 8 is a side elevation view of another exemplary embodiment of an antenna array apparatus according to the disclosure, configured for pole mounting (two stacked rectangular four-sector arrays plus ninth upward sector).

FIG. 9 is a schematic diagram illustrating various feed connection topologies for different antenna element array configurations.

FIG. 10 is a logical flow diagram illustrating one generalized method of manufacturing the antenna element of FIGS. 1A-1D.

All Figures disclosed herein are ©Copyright 2012-2013 Pulse Finland Oy. All rights reserved.

### DETAILED DESCRIPTION OF THE PREFERRED EMBODIMENT

Reference is now made to the drawings wherein like numerals refer to like parts throughout.

As used herein, the terms “antenna,” and “antenna system,” refer without limitation to any system that incorporates a single element, multiple elements, or one or more arrays of elements that receive/transmit and/or propagate one or more frequency bands of electromagnetic radiation. The radiation may be of numerous types, e.g., microwave, millimeter wave, radio frequency, digital modulated, analog, analog/digital encoded, digitally encoded millimeter wave energy, or the like. The energy may be transmitted from location to another location, using, or more repeater links, and one or more locations may be mobile, stationary, or fixed to a location on earth such as a base station.

As used herein, the terms “board” and “substrate” refer generally and without limitation to any substantially planar or curved surface or component upon which other components can be disposed. For example, a substrate may comprise a single or multi-layered printed circuit board (e.g., FR4), a semi-conductive die or wafer, or even a surface of a housing or other device component, and may be substantially rigid or alternatively at least somewhat flexible.

The terms “frequency range”, “frequency band”, and “frequency domain” refer without limitation to any frequency range for communicating signals. Such signals may be communicated pursuant to one or more standards or wireless air interfaces.

As used herein, the terms “portable device”, “mobile device”, “client device”, “portable wireless device”, and “host device” include, but are not limited to, personal computers (PCs) and minicomputers, whether desktop, laptop, or otherwise, set-top boxes, personal digital assistants (PDAs), handheld computers, personal communicators, tablet computers, portable navigation aids, J2ME equipped devices, cellular telephones, smartphones, personal integrated communication or entertainment devices, or literally any other device capable of interchanging data with a network or another device.

Furthermore, as used herein, the terms “radiator,” and “radiating element” refer without limitation to an element that can function as part of a system that receives and/or transmits radio-frequency electromagnetic radiation; e.g., an antenna.

The terms “RF feed,” “feed” and “feed conductor” refer without limitation to any energy conductor and coupling element(s) that can transfer energy, transform impedance, enhance performance characteristics, and conform impedance properties between an incoming/outgoing RF energy signals to that of one or more connective elements, such as for example a radiator.

As used herein, the terms “top”, “bottom”, “side”, “up”, “down”, “left”, “right”, “back”, “front”, and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

As used herein, the term “wireless” means any wireless signal, data, communication, or other interface including without limitation Wi-Fi, Bluetooth, 3G (e.g., 3GPP, 3GPP2, and UMTS), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, Long Term Evolution (LTE) or LTE-Advanced (LTE-A), analog cellular, NFC/RFID, CDPD, satellite systems such as GPS, millimeter wave or microwave systems, optical, acoustic, and infrared (i.e., IrDA).

### Overview

The present disclosure provides, in one salient aspect, a spatially compact and modular antenna element that can be used either alone or as a basic “building block” for larger arrays and sectorial antennas (i.e., by joining needed number of elements together). Thus, the same parts can be reused for various complete product designs, thereby advantageously reducing the need for customized parts (and the attendant disabilities associated therewith, as discussed supra). Moreover, multiple antenna elements can be readily joined together via a common feed network (in one implementation, via the back portion of each element). The antenna gain and beam width are also adjustable through configuration of the array (and the construction of the antenna elements themselves).

In one exemplary application, a base station (e.g., a Small Cell Base Station (SCBS)) unit can be configured (and rapidly reconfigured) with the antenna elements disclosed herein based on individual cell site needs. For instance, the modular antenna elements disclosed herein can be used to configure a 6-sector 360-degree coverage array, or a 3-sector 180-degree coverage array. Likewise, planar or even hybrid (e.g., angular/planar) arrays can readily be formed.

In another aspect, a simplified RF contact configuration is presented to connect the antenna element feed point(s) to the host radio device without need of specific connectors or cables, thereby advantageously further simplifying the use of the element(s) in various applications.

### DETAILED DESCRIPTION OF EXEMPLARY EMBODIMENTS

Detailed descriptions of the various embodiments and variants of the apparatus and methods of the disclosure are now provided. While primarily discussed in the context of base stations or access points, the various apparatus and methodologies discussed herein are not so limited. In fact, the apparatus and methodologies of the disclosure may be useful in any number of antennas, whether associated with mobile or fixed devices.

### Exemplary Antenna Element Apparatus and Methods

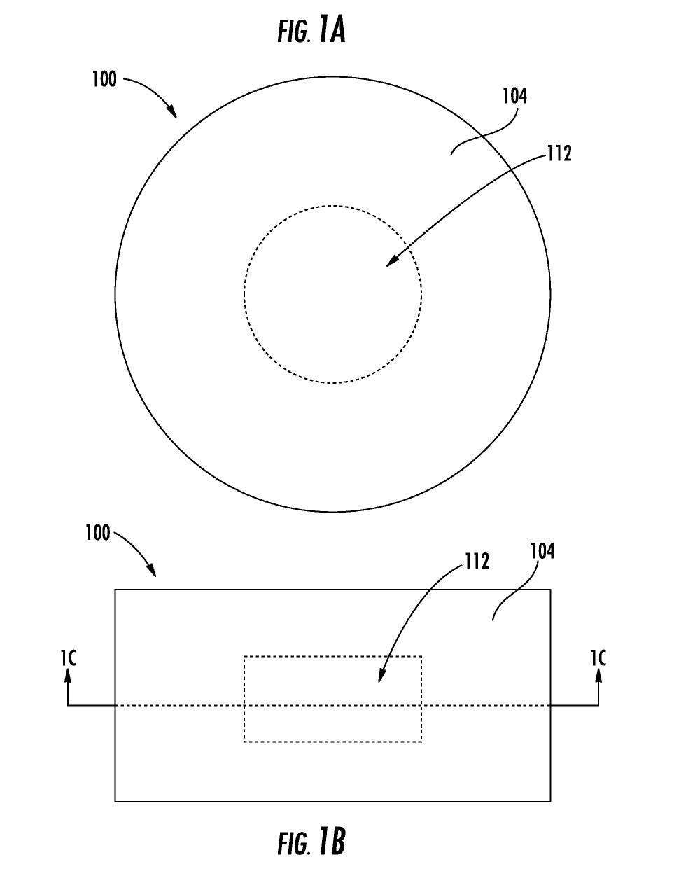

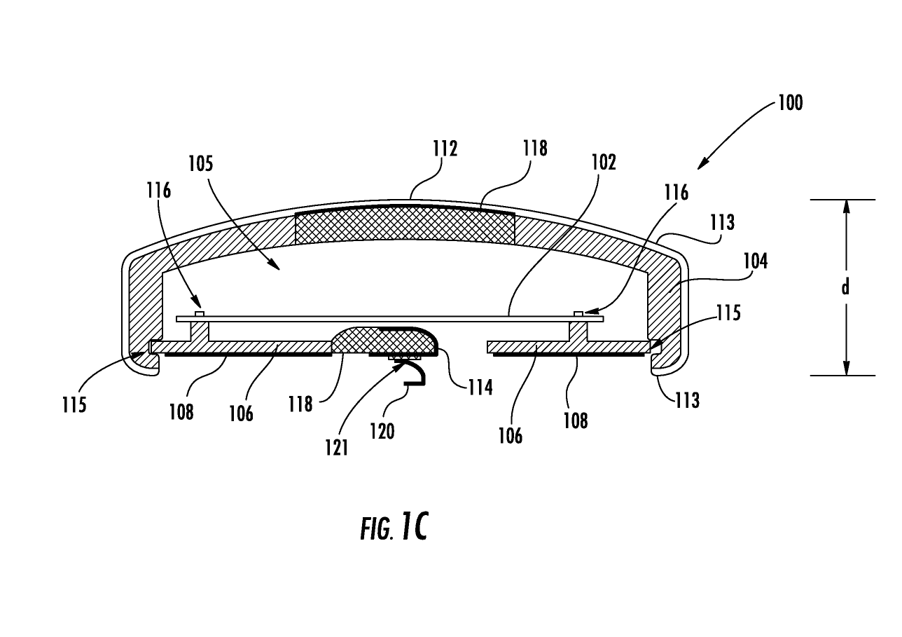

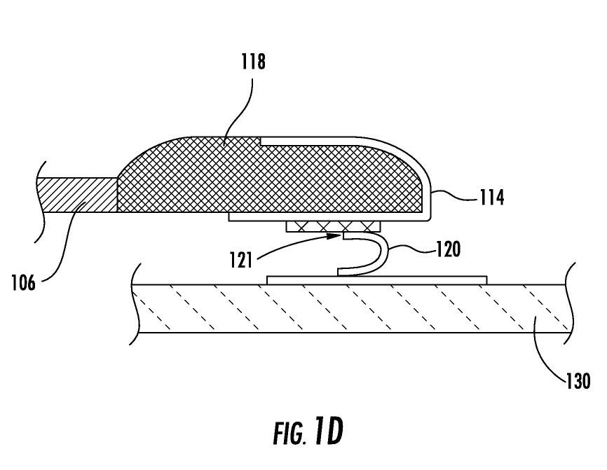

Referring now to FIGS. 1A-1C, an exemplary embodiment of the antenna element 100 configured in accordance with the disclosure is shown and described. FIG. 1A illustrates a generally round (circular) embodiment of the antenna element 100, while FIG. 1B illustrates a rectangular embodiment of the element (which may be readily fashioned as a square shape as well). While the electrical performance of both form factors is similar, certain advantages are associated with the rectangular/square shape in certain applications, including the elimination of gaps left between the elements when assembled in an array (as discussed below). Thus, a substantially “sealed” surface can be formed, which has environmental as well as aesthetic benefits. With the circular elements of FIG. 1A, extra parts/material is needed between elements to fill the gaps and enable joining the elements together.

The illustrated antenna elements 100 of FIGS. 1A-1C each comprise a main radiator element 102, a front cover element (aka radome) 104 with cavity 105 formed therein, a rear cover element 106 with ground plane 108, and a contact element 121. The radome 104 may also include (i) a parasitic radiator element 112 and/or (ii) a covering 113 (e.g., layer of material such paint, laquer, rubber, another layer of plastic, etc.) deposited over at least a portion of the radome 104 for aesthetic reasons as well as environmental robustness (e.g., to inhibit UV damage to the radome 104 or other components due to extended exposure to the sun, moisture, abrasive agents, etc.).

It is noted, however, that even if the mechanical shape of the element cover 104 is square or rectangular as in FIG. 1B, the actual antenna radiator element 102 can be circular, or vice versa.

In one variant, the radome 104 is snap-fit 115 to the rear cover element 106 so as to provide mechanical stability and ease of assembly/disassembly; however, it will be appreciated that other fastening techniques may be used in place of or in conjunction with the foregoing, including e.g. use of adhesives, fasteners, heat staking of one component to the other, press-fit or other frictional technologies, and so forth, as will be recognized by those of ordinary skill given the present disclosure.

Moreover, it can be appreciated that the radome may take on any number of different shapes, the illustrated outwardly (convex) shapes of FIGS. 1A-1C being merely exemplary. For instance, the radome may have a flat (planar shape), or even outwardly concave shape if desired. Similarly, the main radiator 102 may assume different shapes, and/or numbers of constituent elements (e.g., may be angled, bent or curved, comprised of two or more constituent radiator elements, etc.). It is also possible to leave the main radiator 102 out of the element 100 in some cases. The parasitic radiator 112 is such cases functions as the main radiator. As another possibility, metal plating may be applied on both sides of the radome 104. In this fashion, a stacked “patch” (main radiator and parasitic element) can be formed without additional parts.

The antenna element 100 of FIGS. 1A-1C further includes a feed network (with feed point and electromagnetic coupling element) 114 that is, in the illustrated embodiment, applied to the back cover element 106 via an LDS process (described in greater detail below). The back cover element 106 further includes posts 116 to support and retain the main radiator 102, (e.g., by heat staking or other suitable method). By altering the back cover shape, the antenna elements 100 can advantageously be joined together using a common feed network, which further simplifies the resulting array apparatus.

A conductor (in this embodiment, a “C” shaped clip with some resiliency) 120 is also provided to facilitate electrical connection to a host device (e.g., substrate with radio transceiver circuits 130; shown in FIG. 1D). The clip 120 is soldered 121 or otherwise bonded to the feed network 114 so as to form electrical contact therewith. The placement and shape of the clip 120 facilitates ready connection (e.g., frictional contact by virtue of the spring force of the clip, and soldering if desired) to the host device (e.g., a copper layer disposed on a host radio PCB or the like, which is disposed proximate to the rear cover element 106 of the antenna element(s) 106). The C-shaped clip 120 may also be configured to enable mechanical connection to the host device; e.g., by receipt of a portion of the host device structure (e.g., PCB) into the interior region of the clip 120 such that it is frictionally retained therein, such as in the case of a board edge connection.

Use of the foregoing C-clip arrangement advantageously (i) allows for positive mechanical (and hence electrical) frictional contact with a host device without necessitating soldering or other bonding, and (ii) obviates the use of specialize connectors or cables (e.g., coaxial or otherwise), thereby reducing cost and increasing simplicity of design and manufacturing. It will be appreciated, however, that other shapes and/or orientations of conductor may be used with equal success, depending on the particular application. For instance, the C-clip may be oriented at 90 degrees to that illustrated (i.e., rotated out of the plane of the antenna element) and elongated as needed so as to facilitate “side” mounting.

It is further appreciated that while the exemplary embodiment only illustrates the use of one RF feed point, and one main radiator element, the present disclosure is not so limited, and may be implemented with any number of RF feed points (e.g. two-feed, three-feed), as well as any number of antenna elements and/or switching elements as may be required by the particular application.

Moreover, while the parasitic element 112 is shown disposed (e.g., printed) on the outer or convex surface of the cover element (radome) 104, the parasitic element may be formed on the interior (concave) surface, or two or more elements formed on both surfaces if desired. In that no electrical connections are required to the parasitic element(s) 112, their number and location may be varied as required by the application and is facilitated through the use of the multi-dimensional LDS process.

In the exemplary embodiment of FIG. 1C, the main radiator 102 is formed from sheet metal (e.g., an alloy of CuSn, stainless steel, etc.), while the parasitic radiator 112 is formed into the three-dimensional radome outer (and/or inner) surface with a laser direct structuring (LDS) or pad printing process. Specifically, recent advances in antenna manufacturing processes have enabled the construction of antennas directly onto the surface of a specialized material (e.g., thermoplastic material that is doped with a metal additive). The doped metal additive is activated by means of a laser, which enables the construction of antennas onto more complex 3-dimensional geometries. For instance, in a typical smartphone application, the underlying smartphone housing, and/or other components which the antenna may be disposed on or inside the device (in the present element 100, the radome 104), may be manufactured using this specialized material, such as for example using standard injection molding processes. A laser is then used to activate areas of the (thermoplastic) material that are to be subsequently plated. An electrolytic copper bath followed by successive additive layers such as nickel or gold may then be added if needed to complete the construction of the antenna.

In the illustrated element 100 of FIG. 1C, a “two-shot” molding process is utilized for formation of the radome 104, and the back cover element 106. Two-shot molding is an injection molding process using two different resins e.g., an ABS and an LDS plastic; however, only one of the two resins is plate-able.

In the exemplary embodiment where LDS is used, 2-shot molding can advantageously be used to limit usage of LDS plastic to only within the (parasitic) radiator area of the radome 106, and the feed network area of the back cover element 106.

In an alternative embodiment, the aforementioned “2-shot” molding process is obviated through use of a pad printing technique (or other non-LDS printing technique) to form the parasitic radiator 112 on the radome.

In one variant, the LDS parasitic radiator 112 as described above is generally retained; however, manufacturing time can advantageously be reduced by using a meshed or “raster” surface (instead of consistent metallization as in the prior embodiment). Specifically, instead of fully metallized surface, a fine “mesh” is formed. Pitch size of the mesh in the exemplary embodiment is small enough so that from an electromagnetic point of view, the surface appears consistent. When the entire surface does not require the lasering process, a proportional saving in laser treatment time is achieved. Moreover, the amount of metal used is also advantageously reduced. Such rastering (and/or cross-hatching) can be used also in the pad printing process; in that case, the cost saving stems mainly from the reduced amount of metal required.

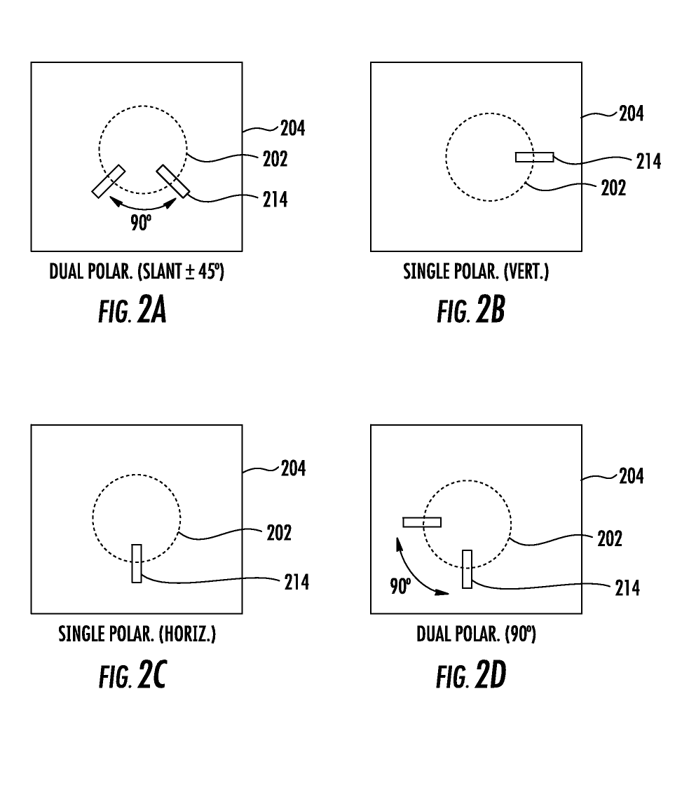

In the exemplary embodiment, polarization of the antenna element 100 can be selected by altering the feed coupling element configuration, single port, dual port, vertical, horizontal, slant +/−45-deg. polarizations are possible; see the exemplary configurations of FIGS. 2A-2D. In these figures, the square shapes 204 comprise an outer perimeter of an exemplary (square) radome, shown from a perspective of the front face thereof. The circular shape is the main radiator 202. The tabs 214 comprise radiator feed points.

The ground plane 108 of the exemplary element 100 comprises a metallic (e.g., copper alloy) layer that in the present embodiment is screen-printed onto the exposed portion of the back cover element 106. As is known, screen printing is a printing technique that uses a woven mesh to support an blocking stencil. The attached stencil forms open areas of mesh that transfer printable material which can be pressed through the mesh as a sharp-edged image onto an underlying substrate. Through placement of the ground plane on the back cover element of the antenna element 100, additional ground (GND) clips can be readily added between ground plane and radio board as needed. The ground plane can be alternatively formed using sheet metal, FPC or other metallization technique (rather than screen printing).

Advantages of the exemplary embodiment of the antenna element 100 include: (i) reduced number of physical parts as compared to prior art solutions; (ii) reduced overall thickness (d) of the element 100 as shown in FIG. 1C, thereby allowing for more spatially compact and less aesthetically “intrusive” designs; (iii) industrial “design freedom” resulting from use of 3D-friendly manufacturing technologies such as LDS; (iv) reusable/reconfigurable antenna elements useful in various base station or other array configurations; (v) low tooling cost due to, inter alia, smaller size thereby requiring less material; (vi) shorter manufacturing lead times/time to market due to obviation of custom designs; (vii) scalability for various frequency bands; and (viii) simple RF contact (e.g., C-clip 120) method from antenna to radio board, thereby obviating custom/expensive RF connectors or cables.

Moreover, the antenna elements disclosed herein have improved RF properties (resulting from, inter alia, the main radiator 102 being disposed in close proximity to the radome). In such a configuration, electrical performance is improved, since the parasitic radiator (or main radiator in the alternate embodiment referenced above) can be formed on the outer surface of the radome 104. Then radome material losses accordingly have little or no effect on antenna radiating performance. Also, the distance between the reflector (ground plane 108) and main radiator 102 can be maximized for a given mechanical height, since the relevant radiator can be formed onto the outer surface of the radome. In conventional antenna technology, the radiator(s) is/are below the radome, and thus closer to the ground plane.

### Antenna Array Apparatus

As indicated above, one salient advantage of the disclosure is its use of identical (or substantially identical) modular antenna elements as “building blocks” which can be joined together in variety of ways to form antenna arrays, panels, columns (cylinders) or other shapes such as polygons. Moreover, various components (e.g., end caps, rear housing element, etc.) can be accommodated into the basic antenna element 100 to form variety of sizes and shapes of antenna assembly, as described in greater detail below. The foregoing capability allows the antenna elements to be largely “commoditized” and have interchangeability, thereby simplifying manufacturing, inventory management, and assembly into antenna arrays.

Moreover, it will be appreciated that the antenna apparatus may be constructed to have at least two-dimensional non-chirality (aka “handedness”), such that its orientation is not critical to its operation. This is particularly useful in manufacturing; i.e., a human or pick-and-place machine may pick up the non-chiral antenna elements as they arrive or are positioned in a source device without having to orient them with respect to the non-chiral dimension(s) before assembly. For instance, considering the round embodiment of FIG. 1A discussed above, the parasitic radiator, main radiator, and feed coupling clip 120 can be structured to mate with the host device in any orientation (e.g., by placing the clip dead-center on the element 100), such that any angular rotation around the central axis is acceptable for purposes of electrical connection to the host, and for the beam pattern (main lobe) of the antenna during operation.

In the exemplary embodiments of the antenna array, the antenna gain and beam width are adjustable by way of the array configuration. For instance, single element 100 can achieve a gain 7 dBi, horizontal 3 dB beam width 65 deg, vertical 3 dB beam width 50 deg. A 1×2 vertical array can achieve a gain 9.5 dBi, horizontal 3 dB beam width 60 deg, vertical 3 dB beam width 30 deg.

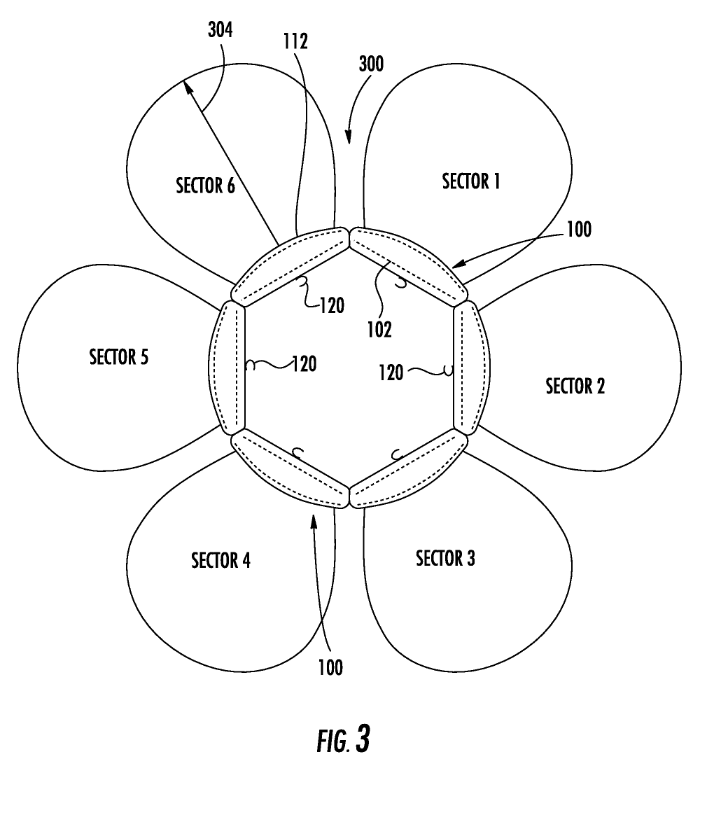

In one configuration of the apparatus, a six-sector array 300 with 360-degrees of coverage is formed using six substantially identical antenna elements 100, as shown in FIG. 3 (radio components not shown for clarity). Hence, each element 100 subtends an arc of 60-degrees, with the radiating (receiving) lobe 304 extending therefrom as shown.

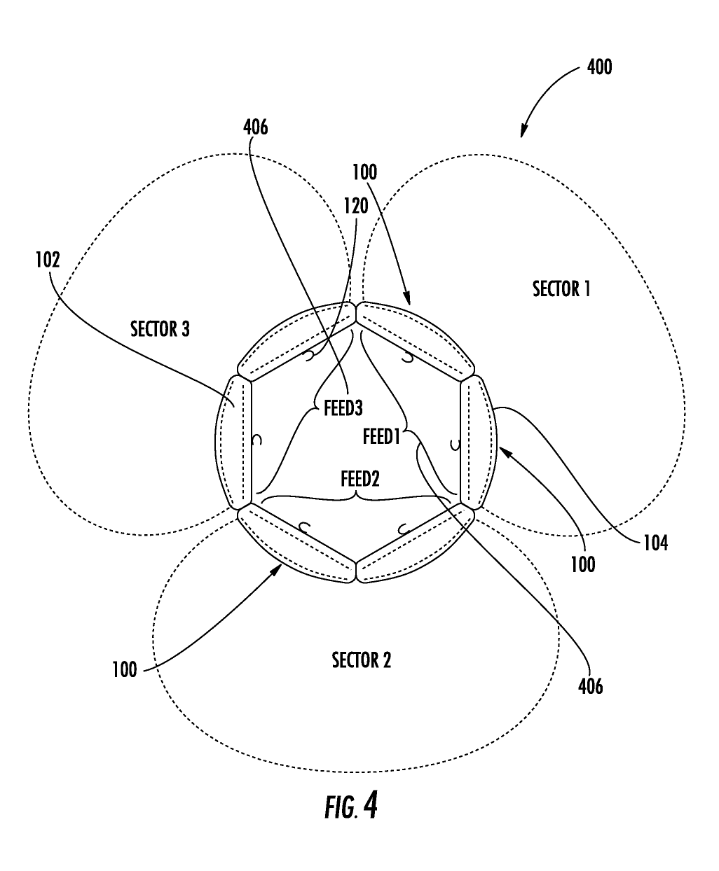

In another configuration, a six-element array 400 is formed, yet with pairs 406 of adjacent elements being coordinated such that three radiating/receiving sectors are formed to cover 360 degrees, as shown in FIG. 4.

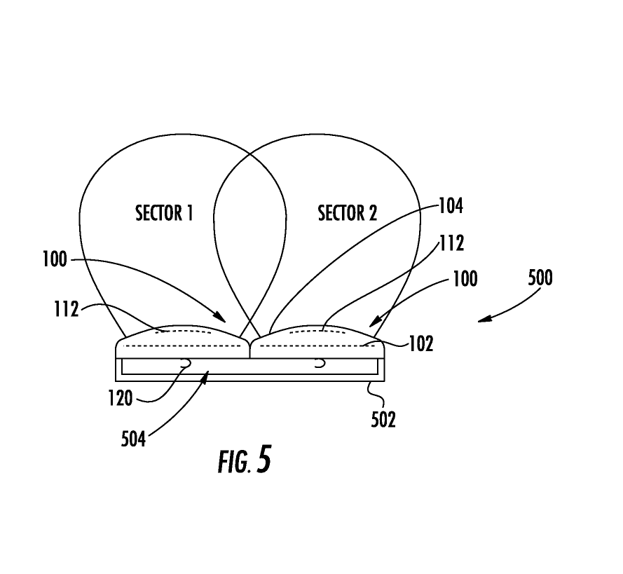

In another configuration, a two-element planar array 500 is formed as shown in FIG. 5. In this embodiment, a rear support member 502 with interior cavity 504 (e.g., for radio components, not shown) is used, although this configuration is but one possible option.

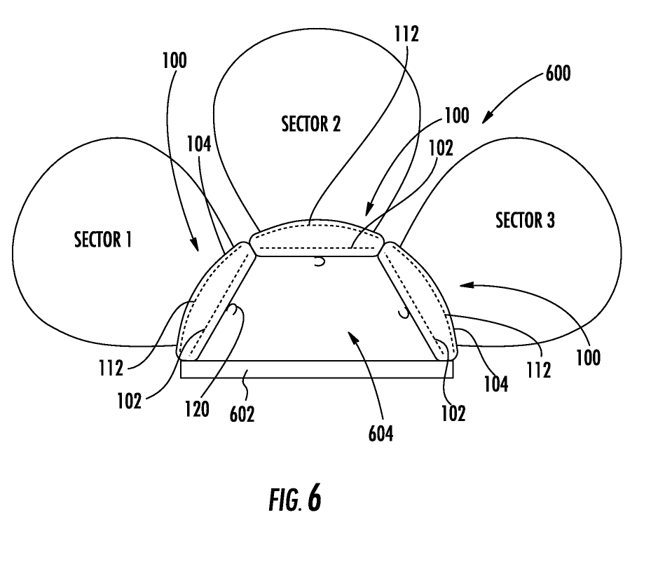

In yet another configuration, a 3-element hemispherical (180-degree coverage) array is formed, the array having three radiating sectors as shown in FIG. 6. A rear support member 602 with cavity 604 is also provided.

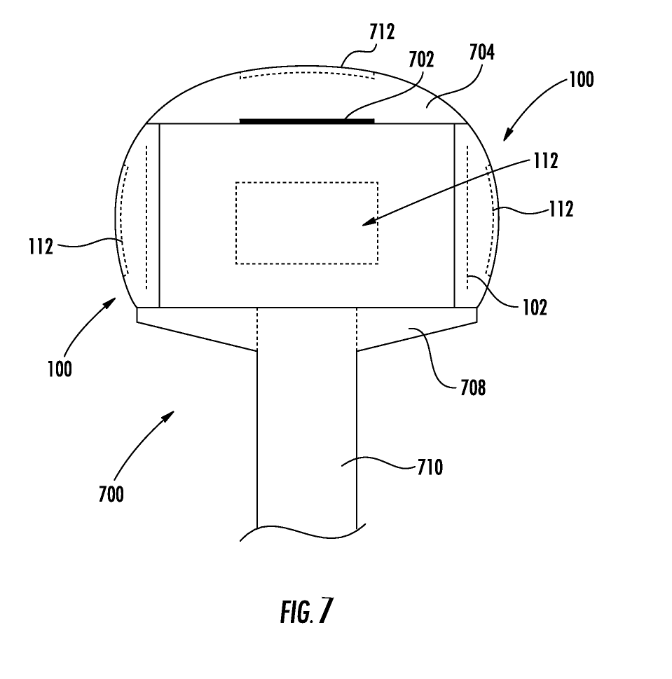

FIG. 7 shows an exemplary embodiment of a pole-mounted antenna array 700 configured according to the disclosure. In this embodiment, four (4) side elements are employed (each having an antenna element 100), and oriented substantially normal to the longitudinal axis of the pole 710. It will be appreciated, however, that any number of other configurations and/or number of elements may be utilized; e.g., six elements in a hexagonal pattern, three elements in a triangular pattern, and so forth. The exemplary configuration of FIG. 7 also includes an optional top-side antenna element 704, which can be used for either heterogeneous or homogeneous RF signals. For example, in one such heterogeneous embodiment, the tope-side element 704 (with embedded main and parasitic elements 702, 712) is configured as a GPS timing or GLONASS antenna, while the four (or other number) of side elements are cellular (e.g., LTE or GSM or CDMA), WMAN (e.g., WiMAX), or the like.

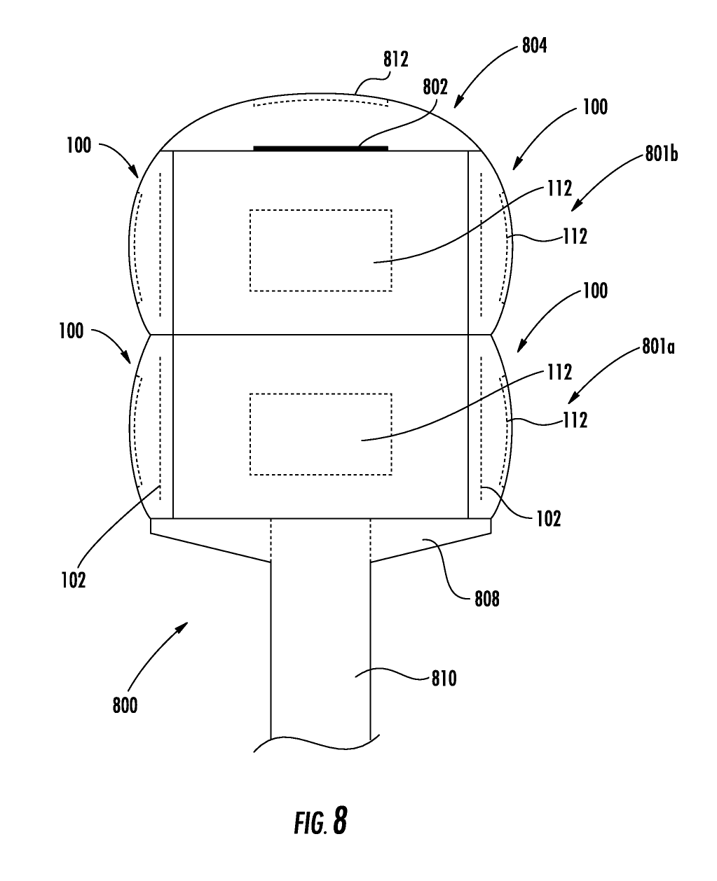

FIG. 8 shows another variant of the pole-mounted configuration, wherein a stacked or layered approach is utilized. In this embodiment, two rows 801a, 801b of antenna elements are stacked vertically (one atop the other), and oriented consistent with each other (i.e., so that the elements of the top row 801b sit directly atop and aligned with those of the lower row 801a when viewed from above. It will be appreciated however that the two (or more) rows may be (i) offset and/or rotated with respect to one another in azimuth; e.g., by 90 degrees; (ii) comprise different numbers of antenna elements (e.g., four on the bottom row, and six on the top row), (iii) may be mounted or constructed such that the main lobe axes are not parallel (e.g., the top row lobe axes canted upward by say 20 degrees from horizontal, while the lower row axes are canted upward at e.g., 10 degrees, or downward at 20 degrees), and/or (iv) comprised of different types of elements (e.g., a first frequency band for the top row, and a second different or partly overlapping frequency band for the bottom row). Hence, myriad different permutations and combinations of the number of elements, number of rows, heterogeneity or homogeneity of the elements, their spatial placement, orientation, and/or disposition, will be recognized by those of ordinary skill given the present disclosure. An optional top element 804 may be used (e.g., for GPS timing or other), with main and parasitic radiator elements 802, 812, if desired.

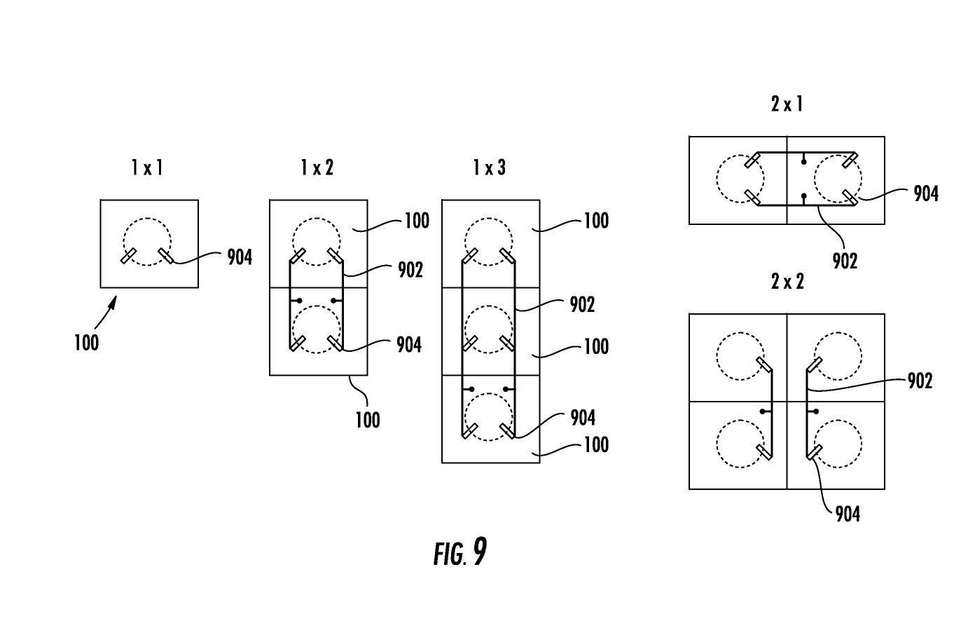

FIG. 9 is a schematic diagram illustrating various feed connection topologies for different antenna element array configurations (i.e., 1×1, 1×2, 1×3, 2×1, and 2×2). In FIG. 9, the lines 902 show the feed network configured to combine individual radiating elements 100 together to form an antenna array. The black dots 904 (2 in each configuration) are the feed points of the array. It is noted that the 1×2 and 2×1 variants are electrically identical, but rotated 90 degrees; the horizontal and vertical beam width of the array radiation pattern of the exemplary embodiment are also reversed when the element is rotated. Hence, in the illustrated configurations, the 1×2 array gives a wide horizontal beam and narrow vertical beam, while the 2×1 beam horizontal and vertical widths are the opposite.

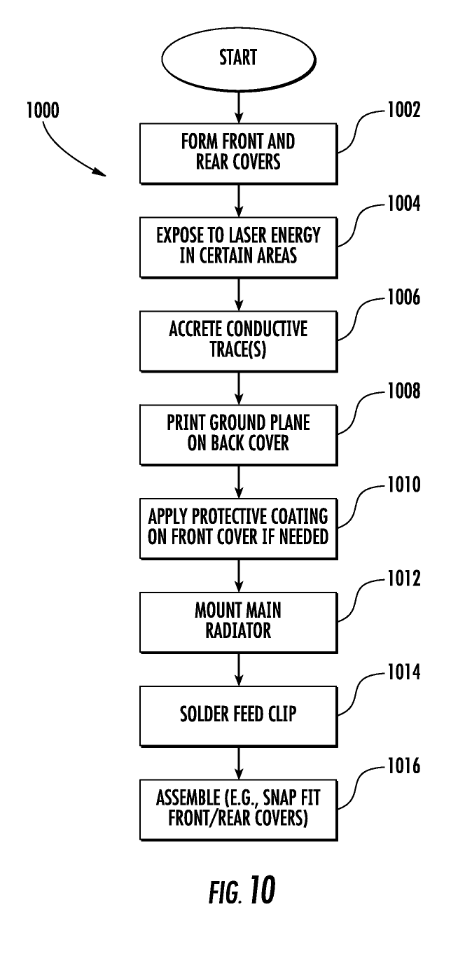

FIG. 10 is a logical flow diagram illustrating one generalized method of manufacturing the antenna element of FIGS. 1A-1D. In this method 1000, the first step is to form the cover element 104 and the rear cover element 106, such as via the aforementioned exemplary “two-shot” injection molding process (step 1002).

Next, relevant portions of the front and rear covers (i.e., those with LDS plastic) are ablated using a laser according to the prescribed LDS process, so as to activate the dopant material contained therein (step 1004).

Per step 1006, the components 104, 106 are then placed in an electroless process so as to build up the desired conductive traces (e.g., parasitic radiator 112, feed network 114, etc.) on the ablated LDS portions.

After completion of step 1006, the ground plane is screen printed onto the relevant portions of the back cover element 106 per step 1008. Any protective coating 113 desired on the front cover 104 may also now be applied per step 1010.

At step 1012, the main radiator element 102 is heat-staked to the rear cover element at the supports 116 (FIG. 1C), and the C-clip soldered to the feed network trace 114 per step 1014. The front cover element 104 is then snapped onto the rear cover assembly at step 1016, and the assembly process is complete.

It will be appreciated that the modular antenna elements disclosed herein (e.g., those of FIGS. 1A and/or 1B, or yet other shapes) may be arranged in a wide variety of shapes and configurations, including for example a dodecahedron, spherical truncated icosahedrons (aka soccer ball), etc. The foregoing shapes and array configurations are accordingly merely illustrative.

It will be recognized that while certain aspects of the disclosure are described in terms of a specific sequence of steps of a method, these descriptions are only illustrative of the broader methods, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure and claims provided herein.

While the above detailed description has shown, described, and pointed out novel features as applied to various embodiments, it will be understood that various omissions, substitutions, and changes in the form and details of the device or process illustrated may be made by those skilled in the art. The foregoing description is of the best mode presently contemplated. This description is in no way meant to be limiting, but rather should be taken as illustrative of the general principles of the disclosure.

What is claimed is:

1. An antenna element, comprising:
a cover element having a cavity formed therein;
a main radiating element disposed substantially within the cavity; and
a coupling element configured to at least electrically couple the antenna element to a host radio frequency device.

2. The antenna element of claim 1, further comprising a parasitic radiating element formed substantially on or within the cover element.

3. The antenna element of claim 2, wherein the parasitic radiating element comprises a laser direct structured (LDS) element formed on an exterior surface of the cover element.

4. The antenna element of claim 3, further comprising an out layer disposed over the exterior surface and at least a portion of the parasitic radiating element, the outer layer selected so as to not substantially degrade the electrical performance of at least the parasitic element.

5. The antenna element of claim 1, further comprising:
a back housing element configured to cooperate with the cover element so as to substantially enclose the cavity; and
a ground plane disposed on the back housing.

6. The antenna element of claim 1, wherein the coupling element is further configured to enable mechanical coupling of the antenna element to a substrate of the host radio frequency device.

7. The antenna element of claim 2, wherein the antenna element comprises a substantially modular construction that is configured to enable the antenna element to be mated with at least one other similar or identical antenna element so as to form an array.

8. An antenna array, comprising:
a plurality of modular antenna elements each comprising:
a cover element having a cavity formed therein;
a main radiating element disposed substantially within the cavity; and
a coupling element configured to at least electrically couple the antenna element to a host radio frequency device; and
a feed structure configured to commonly feed each of the antenna elements.

9. The antenna array of claim 7, wherein the array comprises the plurality of antenna elements arranged in a substantially planar array.

10. The antenna array of claim 7, wherein the array comprises the plurality of antenna elements arranged in a substantially three-sector radial array.

11. The antenna array of claim 7, further comprising a circuit board disposed proximate each of the antenna elements, the circuit board further comprising at least one radio frequency transceiver configured to provide a radio frequency signal to the feed network so as to drive each of the individual antenna elements.

12. The antenna array of claim 7, wherein at least one of the plurality of antenna elements further comprises a parasitic radiating element formed substantially on or within the cover element.

13. The antenna array of claim 12, wherein at least one of the plurality of antenna elements further comprises an out layer disposed over the exterior surface and at least a portion of the parasitic radiating element, the outer layer selected so as to not substantially degrade the electrical performance of at least the parasitic element.

14. The antenna array of claim 13, wherein at least one of the antenna elements further comprises:
a back housing element configured to cooperate with the cover element so as to substantially enclose the cavity; and
a ground plane disposed on the back housing.

15. The antenna array of claim 13, wherein at least one of the antenna elements comprises a first conductive region that has been deposited on the antenna element by a laser-direct structuring (LDS) process, and a second conductive region that has been deposited using a printing process.

16. A method of manufacturing a low-cost, simplified antenna element, the method comprising:
forming a front cover element and a rear cover element, at least one of the front and rear covers being formed using first and second types of material;
activating relevant portions of at least one of the front and rear covers containing the first type of material;
utilizing an electroless process so as to accrete a plurality of conductive elements on the activated portions;
disposing a ground plane onto the back cover element;
disposing a main radiator element on the back cover element;
affixing a feed conductor to at least one of the accreted conductive elements; and
joining the front and rear cover elements.

17. The method of claim 16, wherein the forming comprises using a two-shot injection molding process.

18. The method of claim 16, wherein the activating comprises exposure using a laser, and the electroless process comprises at least portions of a laser direct structuring process.

19. The method of claim 16, wherein the disposing a ground plane comprises screen printing the ground plane.

20. An antenna element, comprising:
a cover element having a cavity formed therein;
a back housing element configured to cooperate with the cover element so as to substantially enclose the cavity;
a main radiating element disposed substantially within the cavity;
a coupling element configured to at least electrically couple the antenna element to a host radio frequency device;
a laser direct structured (LDS) parasitic radiating element formed on an exterior surface of the cover element; and
a ground plane disposed on the back housing;
wherein the coupling element is further configured to enable mechanical coupling of the antenna element to a substrate of the host radio frequency device; and
wherein the antenna element comprises a substantially modular construction that is configured to enable the antenna element to be mated with at least one other similar or identical antenna element so as to form an array.
